(19) United States
(12) Patent Application Publication
(10) Pub. No.: US 2014/0045964 A1
(43) Pub. Date: Feb. 13, 2014

(54) METHOD FOR MANUFACTURING AN ADHESIVE BOND OR COMPOSITE AND ADHESIVE OR MATRIX MATERIAL SUITABLE FOR THIS PURPOSE

(71) Applicant: Fraunhofer-Gesellschaft Zur Foerderung Der Angewandten Forschung E.V., Muenchen (DE)

(72) Inventors: MARCO MARCHEGIANI, Darmstadt (DE); Alexandra Kreickenbaum, Rossdorf (DE); Marvin Bergmann, Alzenau (DE); Jurgen Wieser, Ober-Ramstadt (DE); Peter Spahn, Hanau (DE)

(21) Appl. No.: 13/962,140

(22) Filed: Aug. 8, 2013

(30) Foreign Application Priority Data
Aug. 10, 2012 (DE) 10 2012 015 924.2

(51) Int. Cl. C09J 163/00

(52) U.S. Cl. CPC C09J 163/00
USPC 522/170

(57) ABSTRACT

The present invention relates to a method for manufacturing an adhesive bond between two components, in which an adhesive is used that can be cured with at least two different curing mechanisms. A first curing mechanism here generates less stiffness in the adhesive than at least one second curing mechanism. The layer of adhesive applied to join the components is cured with the first curing mechanism in the region between the components over the entire layer and with the at least second curing mechanism only locally, so that the stiffness of the adhesive layer varies in the region between the components. In like manner, a composite or composite layer can be manufactured with a matrix material, in which the matrix material is varyingly locally cured. The invention also relates to an adhesive or matrix material suitable for the method. The material and accompanying method can be used for many applications.

### TECHNICAL AREA OF APPLICATION

The present invention relates to a method for manufacturing an adhesive bond between two components, or for manufacturing a composite, as well as to an adhesive or matrix material suitable for this purpose.

Modern, resource and energy-efficient structures today often require the non-positive bonding of various materials. For this reason, adhesive technology has gained major importance in the design and manufacture of a wide range of products. It is here especially critical that adhesive bonds with a supporting function be configured and designed. Failure on the part of such structural adhesive bonds is most often accompanied by the threat of serious damage. As a consequence, developing improved adhesives and adhesive technologies for structural adhesive bonds is of special economic interest.

Simple overlapping adhesive bonds represent the most often used adhesive bonding technique. However, the stresses generated through exposure of the bond to external tensile forces are always irregularly distributed over the adhesive surface. If it were possible to distribute these forces more uniformly and avoid stress peaks, these adhesive bonds could be subjected to a higher load. These facts have long been known.

In a simple overlapping adhesive bond between two elastic adherends exposed to a tensile stress, the forces do not act co-linearly, so that the adherends are exposed to tensile and bending loads, and the adhesive layer is simultaneously exposed to shearing and peeling loads. In addition, real adherends exhibit a certain elasticity, i.e., they deform under a load. This results in an inhomogeneous distribution of stress. As the distance from the middle of the overlapping zone grows, the shearing stresses in the adhesive layer rise, and peak at the edge of the adhesive zone. Ignoring the stress-free state in the edge of the adhesive layer to the air, the ratio n between the maximum shearing stress τₘ and average shearing stress τ_{M} is proportional to the square root of the ratio between the shear modulus G for the adhesive and the elasticity modulus E for the adherends:

where τ_{M}=average shearing stress, τₘ=peak shearing stress, l=distance from overlapping midpoint, t=adherend thickness, δ′=adhesive layer thickness, G=shear modulus for the adhesive, E=elasticity modulus for the adherends.

This formula implies that the stress peaks in the edge region can be avoided if the shear modulus G for the adhesive tapers suitably toward the outside. As a consequence, this measure would increase the overall strength of the adhesive bond. This qualitative prediction was confirmed by numerical calculations and experiments.

### PRIOR ART

However, it has to date been difficult to continuously vary the modulus of the adhesive layer. As a result, previous experimental projects were focused on using simple model systems to confirm the principle of stress peak reduction through modulus variation. Use was frequently made of two adhesives, a softer one in the edge region and a harder one in the central region of the adhesive bond, thereby resulting in an incremental variation of the modulus. The varying stiffness of the two adhesives was achieved by using different makes, or softening an adhesive by adding a CTBN rubber adduct. A continuous, but poorly controllable variation of the modulus was achieved by manually scattering glass spheres in varying density into a previously uniform adhesive layer prior to joining. These simple experimental systems were already able to clearly demonstrate an increase in strength for the modified adhesive, in terms of both the incremental and continuous variation of mechanical moduli. Continuous, in particular exponential gradients proved to be especially effective in simulations. However, we still do not yet have a practical method for manufacturing adhesives with continuous gradients.

Even in composites or composite layers in which individual fibers or particles are embedded into a matrix material, it can be advantageous to vary the stiffness of the matrix material via the composite or composite layer. For example, the bending strength can be significantly increased by using a ductile matrix resin on the tension side of a composite and a stiff matrix material on the pressure side. Furthermore, the overall loading capacity can be elevated through targeted modification, e.g., in the area of load application points and openings.

Known in numerous applications for casting, sealing, coating or adhesively bonding are so-called dual-cure systems, which enable simultaneous or consecutive curing with two different curing mechanisms.

U.S. Pat. No. 4,952,342 describes a compound for casting electrical components that consists of two resin systems, a first that cures with UV radiation, and a second that is thermally cured. In the first curing step, UV radiation is used for curing. This solidifies the resin mixture, so that it does not flow away during the thermal curing step, and no channels can be formed by any subsequently escaping gas.

U.S. Pat. No. 5,547,713 describes UV curing epoxy formulations, which are used to seal the back of ceramic components. In this application, the entire surface cannot be exposed to the UV radiation. In order to cure non-exposed regions, use is therefore made of the fact that the generation of acid from the photoinitiator can also be thermally initiated in the presence of copper salts and OH functional polymers. Therefore, the publication combines UV curing and thermal curing by activating the photoinitiator both via UV radiation and thermally. The objective is to uniformly cure the entire surface.

US2003/0207956 describes a dual-cure system for coating substances, preferably for porous materials that combine radiation curing and thermal curing. The goal here is to offset any inadequate radiation curing by a second curing mechanism, or to offset any inadequate thermal curing by radiation curing, or to avoid surface defects like blisters or pores. The described formulation contains at least one radiation curing component, a thermally curing component and a thermally curable component, whose functional groups react with those of the thermally curing component. The preferred thermal curing reaction involves the reaction between OH functional components and polyisocyanates, during which polyurethanes are formed.

In the applications of dual-cure systems known to the applicant, the objective is always to generate as mechanically uniform an end product as possible. Dual-cure techniques are used in particular in UV or light-curing adhesives and lacquers when it cannot be ensured that the complete lacquer or adhesive layer can be uniformly irradiated. The second, often thermally induced curing mechanism then ensures that non-exposed regions are sufficiently cured.

Known from DE 103 47 652 A1 is an adhesive bond comprised of at least two adherend partners, in which the adherend partner is either provided with an adhesive layer with a varying layer thickness and/or with a varying composition of components in the adhesive layer in order to offset the internal stresses caused by different heat expansion coefficients.

DE 10 2007 015 261 A1 discloses a reactive compound with a thermally initiatable matrix former and an energy-absorbing initiator. Finely distributing the initiator makes it possible to obtain a homogeneously constant, high strength for the thermally initiated and completely reacted reactive compound.

Known from U.S. Pat. No. 5,977,682 is a dual-cure adhesive that can be cured both through irradiation with electrons as well as thermally. An irradiation step is intended to only partially cure the adhesive over the entire adhesive surface. Complete curing then takes place within 72 h at room temperature, wherein curing is independent of the received dose of radiation.

DE 602 07 075 T2 describes a coating or adhesive comprised of two oligomers that can react with each other. Involved here are reactive materials that can be processed in the melt, and cured by means of different incremental growth mechanisms to yield uniform coatings.

The object of the present invention is to indicate a method for manufacturing an adhesive bond, a composite or a composite layer as well as an adhesive or matrix material suitable for this purpose, which enables a targeted, local variation in the mechanical stiffness of the adhesive bond, composite or composite layer.

### DESCRIPTION OF THE INVENTION

The object is achieved with the method and adhesive or matrix material according to claims 1, 21 and 25. Advantageous embodiments of the method along with the adhesive or matrix material are the subject of the dependent claims, or may be gleaned from the following description as well as the exemplary embodiments.

The proposed method for manufacturing an adhesive bond between two components involves the use of an adhesive that can be cured with at least two different curing mechanisms, of which a first curing mechanism generates less stiffness in the adhesive than at least one second curing mechanism. The layer of this adhesive applied to at least one of the components to join the components is cured with the first curing mechanism in the region between the components over the entire layer and with the at least second curing mechanism only locally in specific locations to be provided with a higher stiffness, so that the stiffness of the adhesive layer in the region between the components varies in the desired manner.

As a consequence, the idea underlying the solution according to the invention is to suitably combine at least two curing mechanisms in an adhesive so as to generate the modulus variation in the adhesive layer:
A first curing mechanism leading to a softer, more flexible product is to encompass the entire adhesive layer. It is advantageously triggered by heat. Other (first) curing mechanisms, for example chemical reaction with an admixed curing agent at room temperature (2-K systems), exposure to moisture (moisture curing), or even a simple, purely physical solidification through cooling (hot melts), are in principle also conceivable.
In addition, at least one second curing mechanism is locally triggered, which elevates the crosslink density and locally increases the hardness of the adhesive layer. This local increase in hardness is advantageously generated through irradiation, since it can be easily varied in terms of time, location and intensity. For example, the local intensity distribution of UV radiation can be easily controlled and regulated, e.g., with a diaphragm, filter or through laser scanning, so as to generate both incremental and continuous adjusted modulus gradients as desired.

For example, the proposed method can be used to vary the adhesive stiffness from soft, less soft at the edge of the adhesive, to harder and stiffer in the middle of the overlapping region of the components. While this variation can be incremental, it is especially preferred that this variation in mechanical modules be continuous. As a consequence, the proposed method can be used to easily and readily controllably generate a continuous or incremental modulus variation in a previously uniform adhesive during the curing process. The regions with a lower stiffness, which were only cured with the first curing mechanism, here also exhibit a higher ductility than the additionally hardened regions, allowing them to expand to a greater extent. Therefore, in the overlapping adhesive described above, not only does the stiffness taper off from the middle of the overlap toward the edges, the ductility also increases in this direction. Preferably used for this purpose is a thermally curing epoxy adhesive, whose hardness can be locally elevated through targeted UV irradiation before joining the adherends.

The above concept for varying the hardness of the adhesive can also be used in manufacturing a composite or a composite layer, in which fibers and/or particles are embedded into a matrix material. The matrix material is here selected in the same way as the above adhesive, so that it can be cured with at least two different curing mechanisms, of which a first curing mechanism produces a lower stiffness of the matrix material than at least one second curing mechanism. After the matrix material is mixed with the fibers and/or particles, it is then cured with the first curing mechanism over the entire composite material layer, and with the at least second curing mechanism only locally at the specifically desired locations, so that the stiffness of the matrix material varies over the composite or composite layer in the desired manner. In a preferred embodiment, this variation is carried out so as to cure the matrix material with the at least second curing mechanism only on one side of the composite or composite layer, so that the stiffness of the matrix material is greater on one side of the composite or composite layer than on the opposite side.

In principle, the two curing mechanisms can be initiated one after the other, in whatever sequence desired, or at the same time. When using at least one second curing mechanism triggered by radiation, however, the approach described below is especially advantageous for manufacturing an adhesive bond, because it also allows adherends that are more impervious to radiation to be adhesively bonded.

After the adhesive has been applied to one of the parts to be joined, the region to be cured is first irradiated. It is especially preferred that the curing mechanism activated by radiation here not solidify the adhesive right away, since this might otherwise cause it to lose its adhesiveness. Instead, the radiation is supposed to initially only prepare, i.e., pre-activate, the (second) curing mechanism intended for local curing. The onset of the reaction is to be delayed in such a way that the parts can still be joined after irradiation. Joining then takes place, so that the adhesive layer is no longer accessible to further irradiation. Curing of the entire adhesive layer is then initiated with the first mechanism, thereby yielding the softer product, and the process of increasing local hardness is concluded, for example by heating the adhesive to a temperature above room temperature.

The possibility of pre-activated curing is already known from cationic UV-curing epoxy adhesives. Suitable products are commercially available, for example from DELO (Katiobond products).

However, a practice-oriented and industrially suited adhesive system requires the satisfaction of various other conditions, which complicate the chemical realization of the idea. It is especially important to ensure that a stable end state be achieved:

The process of increasing hardness must not subsequently continue in the non-irradiated regions of the adhesive layer, which are to remain softer. For this reason, reactions between reactive chemical groups must have largely run their course both in regions where only one curing mechanism is underway, as well as in regions cured with at least two curing mechanisms. This necessity is also supported by the observation that while incompletely cured structural adhesives might be soft, they are generally not loadable from a mechanical standpoint and when in contact with media, thus rendering them useless. However, if the objective is to achieve complete curing in the simply cured regions already, the expert previously had to conclude that it is impossible to generate a significant stiffness gradient using a dual-cure system. It is preferred that the proposed method here be used to achieve at least a 30% variation in stiffness or ductility (e.g., ultimate elongation) via the layer.

Preliminary studies for determining a suitable adhesive initially did not result in the desired properties either. The focus was on whether there is a thermally-initiated curing mechanism that can be combined with the cationic, pre-activated UV curing of epoxy resins, and whether varying combinations of the two mechanisms make it possible to generate mechanical differences.

During the cationic, UV-activated curing of epoxy resins, UV-irradiation causes the photoinitiator to release a cationically active species, most often the proton of a strong acid, which subjects the oxirane rings of the epoxy resin to ring-opening polymerization. Sulfonium and iodonium salts are commercially available as the photoinitiator for the cationic, activated UV-curing of epoxy resins. For toxicological reasons, preference must be given to iodonium salts, which exhibit no benzene separation during UV irradiation. The iodonium salt Deuteron 1242 was successfully used during the preliminary examinations. The comparable iodonium salt Irgacure 250 was subsequently employed.

It was discovered that the cycloaliphatic epoxy resins typically used for UV curing react too fast. Instead of a pre-activation followed by full curing, skin formation was observed, which impairs the subsequent joining process. It was shown that an inexpensive bisphenol-A-(BPA)-liquid resin, Epilox A 19-03, Leuna Harze, could be processed more effectively, because it cured more uniformly, even in thick layers, and exhibited less of a tendency toward skin formation. Such low-molecular BPA resins are typical main constituents in commercial epoxy adhesives, as confirmed by the relevance of the selected resin type in practice. In these low-molecular BPA-based liquid resins, the average number of repeating units typically measures n<<0.5. This means that these resins have almost no OH groups. Higher-molecular resins having more OH groups are solid, and thus less suitable when liquid adhesive formulations are required.

When selecting the curing agent for the curing mechanism to be thermally initiated, it was found that any alkaline reacting substances effectively impeded UV curing. This precludes amine curing agents and dicyandiamide derivatives as curing agents, along with tertiary amines, ammonium salts, imidazoles, urones and guanidines as the accelerators or catalysts. Only anhydrides like hexahydrophthalic acid anhydride did not disrupt UV curing. However, it was observed that these anhydrides did not induce a sufficient curing reaction at practice-oriented curing temperatures of up to 180° C. when used alone, without a typically added alkaline accelerator like ethyl methylimidazole. This behavior has long been known. Therefore, a search was conducted to find a suitable accelerator for anhydride curing that did not detract from UV curing. The literature describes a plurality of wide-ranging substances as possible accelerators for the thermal curing of epoxy resins with anhydrides, to also include metal compounds and phosphorus-containing compounds as an alternative to the usual nitrogen-containing alkalines. In particular certain metal complexes or metal chelates proved highly promising, since they had little detrimental effect on UV curing. Given its good effectiveness at a low toxicity, zinc chloride dissolved hot in acetylacetone was finally selected as the accelerator. However, this is not intended to fundamentally preclude other compounds of zinc, in particular commercially available zinc chelates or carboxylates like Nacure XC 9206 from King Ind., compounds of other metals, phosphorus compounds and other accelerators known from the literature.

As a result, it was possible to formulate a simple dual-cure system with the following components:
Low-molecular, BPA-based epoxy liquid resin: Epilox A 19-03,
Anhydride curing agent: Hexahydrophthalic acid anhydride,
Accelerator: Zinc chloride, dissolved hot in acetylacetone (2,4-pentanedione),
Photoinitiator for cationic epoxy curing: Deuteron 1242
   which could be fully cured both purely thermally by the anhydride and, after pre-activated with UV-irradiation, cationically at temperatures of about 135° C. The ideal chemical formulas for the components are shown on FIG. 2. FIG. 2a here presents the photoinitiator Deuteron 1242 (bis(4-dodecylphenyl)-iodonium hexafluoroantimonate, FIG. 2b the photoinitiator Irgacure 250 (4-methylphenyl) [4-(2-methylpropyl)phenyl]-iodonium hexafluorophosphate, FIG. 2c the basic structure of a bisphenol-A-based epoxy resin (n˜0.14 for Epilox A 1903), FIG. 2d the cycloaliphatic epoxy resin Uvacure 1500, Araldite CY179, typically used in cationic UV-curing, FIG. 2e a hexahydrophthalic acid anhydride, and FIG. 2f the oligomers of the glycerin diglycidyl ether. Since technical products are involved, deviations from the ideal formula caused by impurities can be expected. According to the determined optimum for curing with hexahydrophthalic acid anhydride, the process was started with an epoxy resin:anhydride mass ratio=50:30, which corresponds to a substance amount ratio n(epoxy) n(anhydride)=1:0.7. Further attempts yielding comparable results were performed with a reduced anhydride content up to a substance amount ratio of n(epoxy):n(anhydride)=1:0.35.

In the manufactured formulation, the epoxy resin Epilox A 19-03 provides epoxy groups (oxirane rings) for the reaction, in a good approximation of two per molecule in the terminal position (n˜0.14). FIG. 3 provides a highly simplified summary of the basic reactions to be expected while subjecting the formulation to cationic polymerization and anhydride curing. During exposure to the cation released from the photoinitiator, each of the two epoxy groups can in combination with the epoxy groups of other molecules build a polymer chain through ring-opening polymerization. A very tightly meshed network comes about. FIG. 3a provides a highly simplified schematic view of the reaction. Alternatively, the epoxy resin can react with the anhydride (anhydride curing on FIG. 3b). Each epoxy group can here mathematically fully convert an anhydride, which corresponds to two carboxylic acid functions. A highly simplified examination makes it possible to distinguish between two reaction steps. The anhydride can form an ester by reacting with OH groups, which simultaneously frees a carboxyl group, which in a second step can react with another OH group, or preferably with an epoxy ring. The latter reaction again generates an OH group, which is then once more available for reaction with the anhydride. The exact mechanism of anhydride curing has proven to strongly depend on the type of used accelerator.

As evident from the simplified examination, the following applies to the formulation:
Cationic UV-curing only requires epoxy groups for polymerization;
Curing with the anhydride requires epoxy and anhydride groups, OH-groups that come about during the reaction can also react with additional anhydride;
At the beginning of the reaction, the epoxy resin provides almost exclusively epoxy groups, which can be consumed via cationic, ring-opening polymerization or through reaction with the anhydride;
To prevent any anhydride from remaining behind in areas where cationic curing and anhydride curing take place concurrently, the lowest possible anhydride concentration should be used, if possible under the stoichiometric ratio of n(epoxy):n(anhydride)=1:0.7-0.8 recommended for pure anhydride curing.

The hope was that the product resulting from incorporating the anhydride into the network would exhibit other mechanical properties, preferably a higher flexibility and lower stiffness than the especially tightly meshed, cross-linked product that had been subjected to cationic ring-opening polymerization. Unfortunately, this expectation proved not to be fulfilled. While it could be demonstrated that a dual-cure system that could be cured cationically after UV irradiation or with anhydride was in fact present, the products obtained in both instances were mechanically very similar. Comparably stiff and sparingly ductile products were always obtained. UV irradiation has no significant impact on stiffness, for which the modulus of elasticity is a gauge. Approximately the same modulus of elasticity was measured with and without irradiation. As a result, this dual-cure system is not suitable for an adhesive bond with a reduced stress peak.

However, further examinations surprisingly revealed to the inventors that using special epoxy resins at specific stoichiometries between the epoxy resin and anhydride curing agents resulted in dual-cure systems with which the desired sufficiently strong mechanical gradient in the adhesive can be generated through local UV-irradiation.

These resins exhibit the following peculiarities:
They carry epoxy groups whose cationic UV curing can be initiated with the conventional photoinitiators, and
which are likewise suitable for curing with anhydrides;
They further carry OH groups or form OH groups during the curing reaction, which are also suitable for reaction with anhydrides;
The quantity of these OH groups is sufficient for reactively binding excess anhydride or carboxylic acid formed from the latter that were not already made to react by epoxy groups.
The quantity of the OH groups is not so high as to result in disadvantageous product properties that would make the cured products unsuitable for practice, for example because they would be water soluble or highly swellable with water;
The resins are capable of yielding more flexible curing products.

The OH functions here assume a special role. OH groups cannot react with themselves at room temperature, and require a complementary reactive group for a curing reaction, for example an isocyanate function. Products that almost exclusively contain only OH groups as potentially reactive functions satisfy this criterion because they can be regarded as stable and nonreactive at room temperature. For this reason, they do not detract from long-term stability in the end product in large amounts, and can even be advantageous in light of their high polarity, since they can elevate the adhesion of adhesives to metals.

Suitable OH-functional epoxy resins are commercially available, in particular for use as lacquers. Suitable resins include the low-viscosity, oligomeric glycidyl ethers of glycerin (glycidyl ether GE100, Raschig; Epikote 812, Momentive) and high-molecular, BPA-type epoxy resins with n>1, such as Epikote 1004, Epikote 1007 and 1009, Momentive; DER 663, 664, 667, 668, 669, Dow; Epilox A 85-02, Leuna Harze and Araldite GT 6084, 6097, 6099 from Huntsman. The high-molecular, BPA-type resins are solid at room temperature, and can be suitable for elevating the viscosity of liquid adhesives or generating formulations for adhesives to be processed as an adhesive film. Of course, similar high-molecular, and hence OH-rich, epoxy resins with a different composition could also be suitable, for example those based on bisphenol-F. Also known relative to these oligomeric or high-molecular resins is that they can yield more flexible products, as opposed to low-molecular resins with a comparable composition.

However, it might not be absolutely necessary for the epoxy resin to be the sole carrier of OH groups before the curing reactions begin. The helpful OH functions according to the invention could also be introduced into the adhesive formulation by
Adding an oligomeric or polymeric, OH-rich component (polyol),
Using an OH-functional carboxylic acid or a corresponding anhydride (salicylic acid) as the curing agent, or
Previously modifying the anhydride with an OH-containing component (adduct formation, leads to an anhydride or carboxy-functional polyester), so that similarly suitable end products are on hand after curing.

In contrast to the formulation with few OH-groups tested without success during the preliminary studies, OH-groups are available from the very outset in the epoxy resin for reaction with the anhydride curing agents in the formulations according to the invention. As could be demonstrated, this has very significant implications for the mechanical properties of the products hardened through anhydride curing alone, and of the products additionally hardened through cationic UV curing.

It was further discovered that, in the OH-rich formulations, the stoichiometric ratio between the anhydride functions and epoxy functions has a critical influence on the magnitude of the mechanical difference between the products cured only with anhydride and those that were also UV-irradiated.

As a consequence, the fundamental principles underlying the system according to the invention are as follows:
A first curing mechanism acts on the entire adhesive, wherein this can also involve a physical process (hot melt adhesives);
At least one second curing mechanism exerts a local action, preferably initiated through local irradiation;
The at least second curing mechanism results in an increased hardness of the adhesive.

In a first variant of the method, chemical implementation of the principles requires components with
At least one first type of chemical functions, which are reactive in the curing mechanism acting both locally and on the entire adhesive;
At least one second type of chemical functions, which are reactive in the curing mechanism acting on the entire adhesive;
At least one third type of chemical functions, which as cross linking agents can react with both the first and second type of chemical functions;
Both the first curing mechanism and second curing mechanism yield a stable end state in which the reactive groups have completely reacted;
The different chemical functions can be distributed among various molecules or be present together on molecules;
The formulation can contain other components, for example additives and fillers.

In a preferred chemical implementation, the first and second chemical functions are present together on molecules.

An embodiment of the adhesive or matrix material according to the invention uses formulations with components that satisfy the following preconditions:
The first type of chemical functions, which is reactive during local radiation curing, is the epoxy group. The used epoxy resins can be low-molecular (reactive diluents), oligomeric or polymeric.
The second chemical function, which is primarily reactive in curing the entire irradiated or non-irradiated adhesive, is the OH-group.
A significant percentage of the components advantageously contains both epoxy groups and OH-groups.
The third type of chemical functions, which as a cross-linking agent can react with the epoxy functions and also the OH functions, is the carboxylic acid function. It can also be present in dehydrated form as a carboxylic acid anhydride function.
The formulation can contain other components, for example additives or fillers.

In another preferred method, thermal curing is used as the first curing mechanism, and UV-curing is used as the at least second curing mechanism. UV curing here takes place with at least two different UV-initiated cross-linking mechanisms.

Especially preferred here is a method in which radical polymerization takes place as the first cross-linking mechanism. In the second cross-linking mechanism, double bonds in one component of the adhesive or matrix material react with thiols, and cross-linking takes place by way of a thiol-ene reaction.

Another variant of the method involves using an adhesive or matrix material that exhibits at least one first type of chemical functions, which are reactive in the first curing mechanism, exhibits at least one second type of chemical functions, which are reactive both in the first and at least in the second curing mechanism, exhibits at least one third type of chemical functions, which as cross-linking agents can react both with the first and second type of chemical functions, exhibits at least one fourth type of chemical functions, which are reactive both in the first and at least in the second curing mechanism, and that both the first curing mechanism and the at least second curing mechanism yield a stable end state in which reactive groups have reacted completely. It is here especially preferred that the first type of chemical functions be reactive exclusively in the first curing mechanism, i.e., the first type of chemical functions is in particular not reactive in the at least second curing mechanism.

Especially preferred is a method involving the use of an adhesive or matrix material in which the first type of chemical functions consists of epoxy groups, the second type of chemical functions consists of acrylate groups, the third type of chemical functions consists of amine groups, and the fourth type of chemical functions consists of thiol groups.

Another adhesive or matrix material according to the invention, especially one for manufacturing an adhesive bond or composite layer according to one of claims 17 to 20, can be cured with at least two different curing mechanisms, of which a first curing mechanism generates a lower stiffness for the adhesive or matrix material than at least one second curing mechanism. The adhesive or matrix material exhibits at least one first type of chemical functions, which are reactive in the first curing mechanism, exhibits at least one second type of chemical functions, which are reactive in both the first and at least in the second curing mechanism, exhibits at least one third type of chemical functions, which as cross-linking agents can react both with the first and second type of chemical functions, and exhibits at least one fourth type of chemical functions, which are reactive both in the first and at least in the second curing mechanism. It is here especially preferred that the first type of chemical functions be reactive exclusively in the first curing mechanism, i.e., the first type of chemical functions is in particular not reactive in the at least second curing mechanism.

The adhesive or matrix material is preferably characterized by the fact that the first type of chemical functions consists of epoxy groups, the second type of chemical functions consists of acrylate groups, the third type of chemical functions consists of amine groups, and the fourth type of chemical functions consists of thiol groups.

### BRIEF DESCRIPTION OF THE DRAWINGS

The proposed method along with the proposed adhesive and matrix systems will be described once again in greater detail below based on exemplary embodiments in conjunction with the drawings. Shown on:

FIG. 1 is a schematic view of an exemplary process for manufacturing an adhesive bond with the proposed method;

FIG. 2 are examples of ideal formulas for the components present in an exemplary adhesive;

FIG. 3 are examples of reaction mechanisms while curing the adhesive;

FIG. 4a/b is an example of a tensile test performed on specimens cured at 135° C. without (a) and with (b) 40 minutes of UV-irradiation at a stoichiometry n(epoxy):n(anhydride)=1:1.2;

FIG. 5a/b is an example of a tensile test performed on specimens cured at 135° C. without (a) and with (b) 40 minutes of UV-irradiation at a stoichiometry n(epoxy):n(anhydride)=1:0.7;

FIG. 6a/b is an example of a tensile test performed on specimens cured at 125° C. without (a) and with (b) 40 minutes of UV-irradiation at a stoichiometry n(epoxy):n(anhydride)=1:0.4;

FIG. 7a/b is an example for the influence of curing temperature and irradiation time on the tensile test results;

FIG. 8 is an example for the Shore A hardness of a test rod fabricated with the method according to the invention over the length of the rod;

FIG. 9a-d are results obtained from tensile elongation tests with various adhesive formulations;

FIG. 10 are results obtained from tensile elongation tests performed on a dual-cure formulation consisting of an epoxy-amine system and an epoxy acrylate;

FIG. 11 is an example for the progression of the Shore D hardness of a dual-cure formulation consisting of an epoxy-amine system and an epoxy acrylate;

FIG. 12 are results obtained from tensile elongation tests performed on an adhesive formulation with varying UV-irradiation times: 0 min, 0.5 min, 1 min, 2 min and 5 min;

FIG. 13 is the progression of surface hardness for an adhesive formulation irradiated on one side with two UV-initiated cross-linking mechanisms;

FIG. 14 are DSC curves for an adhesive formulation with two UV-initiated cross-linking mechanisms; the irradiation time was varied.

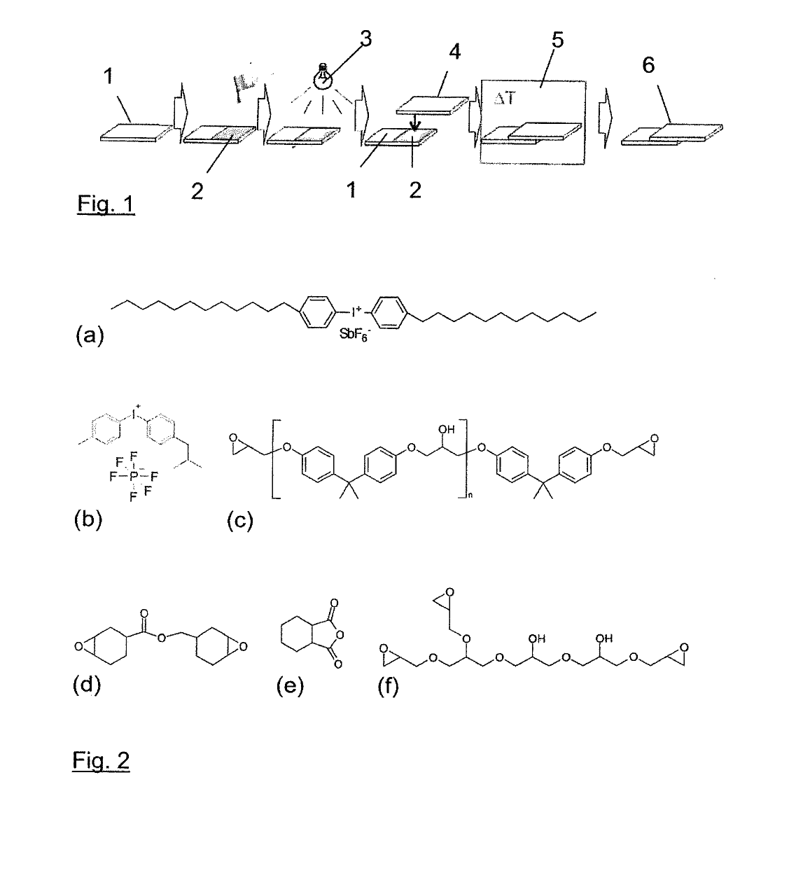

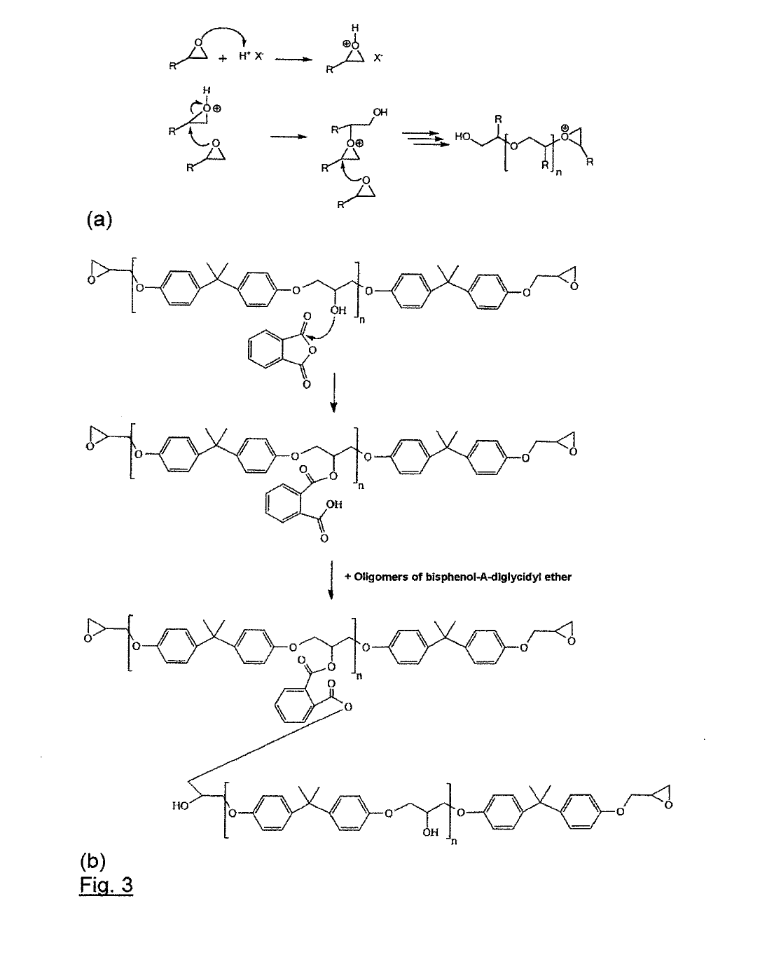

### WAYS OF IMPLEMENTING THE INVENTION

In the proposed method, an adhesive bond is manufactured using an adhesive that can be cured with two curing mechanisms. A first curing mechanism here yields a softer, more flexible product, and is activated in the entire adhesive layer. A second curing mechanism generates an elevated stiffness by comparison to the first curing mechanism, and is only locally initiated at desired locations on the adhesive layer in order to achieve a varying stiffness of the adhesive layer after curing. In the following examples, a thermal curing activated by heat is used as the first curing mechanism, and a UV-irradiation curing is used as the second curing mechanism. Exemplary adhesive formulations suitable for use in the method will also be described below.

FIG. 1 here shows a schematic view of the manufacture of a stress-reducing adhesive bond with modulus variation in the adhesive by combining such a thermal curing process with an increase in hardness through local UV activation. In the method, adhesive is first applied to the region of the adherend 1 to be joined. Only specific locations of the applied adhesive layer 2 are then irradiated with a UV radiation source 3. For example, this can take place by way of suitable diaphragms or using a laser as the light source, guiding its beam over the regions to be irradiated. The adherend 1 and a second adherend 4 are subsequently bonded via the adhesive layer 2, and the bond is thermally cured in an oven 5. After the adhesive bond has been fully cured, the two joined parts 6 can be removed from the oven.

An example for manufacturing a suitable adhesive formulation will initially be presented below.

The proposed formulation consists of glycidyl ether GE100 from Raschig with hexahydrophthalic acid anhydride, zinc chloride, dissolved hot in acetylacetone, and the photoinitiator Irgacure 250 from BASF SE.

A formulation according to the invention with glycidyl ether GE100 was here manufactured as follows:

18 g of epoxy resin glycidyl ether GE100 were placed in a disposable cup made of PP with a capacity of about 30 mL. 7.5 g of hexahydrophthalic acid previously fused at 50-60° C. in a drying closet were then added. 0.45 g of Irgacure 250 were subsequently added, and the mixture was manually mixed with a spatula. 1.50 g of an 80° C., hot saturated solution of anhydrous zinc chloride in acetylacetone were then added, and the mixture was manually mixed with a spatula.

Formulations with stoichiometric ratios of n(epoxy):n(anhydride)=1:0.39, n(epoxy): n(anhydride)=1:1.2 and n(epoxy): n(anhydride)=1:0.7 were prepared for a tensile test.

The low-viscosity mixture was exposed to a vacuum in the vacuum drying closet to manufacture the specimens. This caused the air bubbles contained in the mixture to expand very strongly, rise and open. A liquid seemingly completely free of bubbles was obtained. The liquid was filled into a homemade silicone mold for miniature test rods with a disposable dropper. UV irradiation was performed in a UV cube made by Hoenle, with a mercury high-pressure lamp in a cold-mirror configuration, arc length 10 cm, power 100 W/cm. During irradiation, the samples were stored spaced about 50 cm apart from the light source in ambient air. After irradiation, the silicone molds were placed in a drying closet preheated to 80° C. The desired temperature was increased to 135° C. immediately thereafter. This temperature was reached after about 30 minutes. After another 60 minutes, the oven was turned off for cooling purposes. After cooled, the silicone molds with the fully cured samples were removed to room temperature, and the test rods were subjected to the tensile test, during which the test rods were loaded to the breaking point at room temperature and a testing speed of 2.5 mm/min.

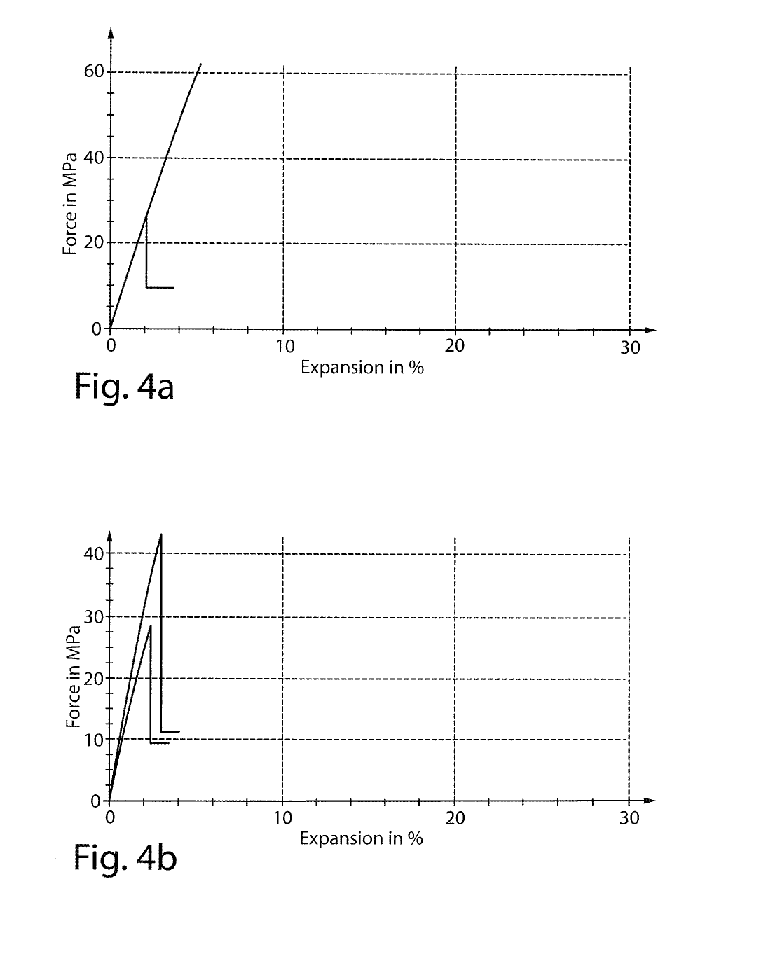

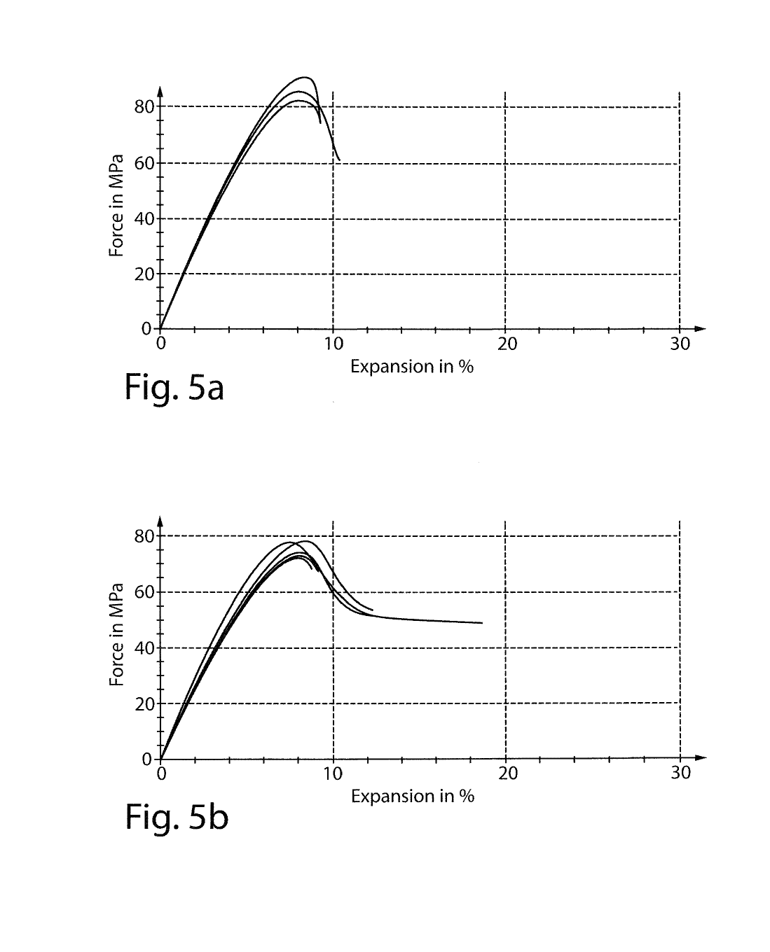

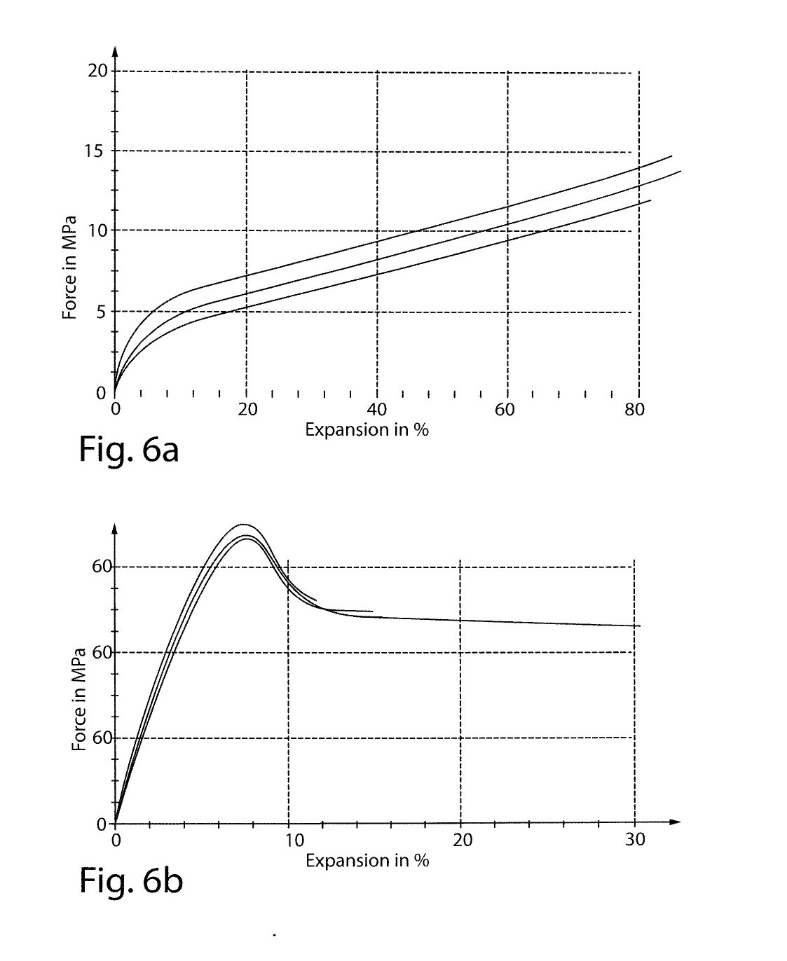

FIGS. 4 to 6 present the results obtained from the tensile tests performed on samples manufactured out of the above formulations with varying stoichiometric ratios of n(epoxy):n(anhydride), all based on the glycidyl ether GE100 resin and hexahydrophthalic acid anhydride. The figures show a partial image (a) of the respective result without and a partial image (b) of the result with 40 minutes of UV irradiation. The results highlight the influence of stoichiometry on the difference between the mechanical properties that can be achieved through additional UV irradiation. Only by reducing the share of anhydride are mechanically highly variable products obtained with and without UV irradiation.

At a stoichiometry n(epoxy):n(anhydride)=1:0.4, anhydride, acid or epoxy could no longer be detected in significant quantities via infrared spectroscopy after curing in either the UV irradiated samples or other samples. This satisfies the condition that the reactive groups must have reacted completely after curing for there to be a stable product.

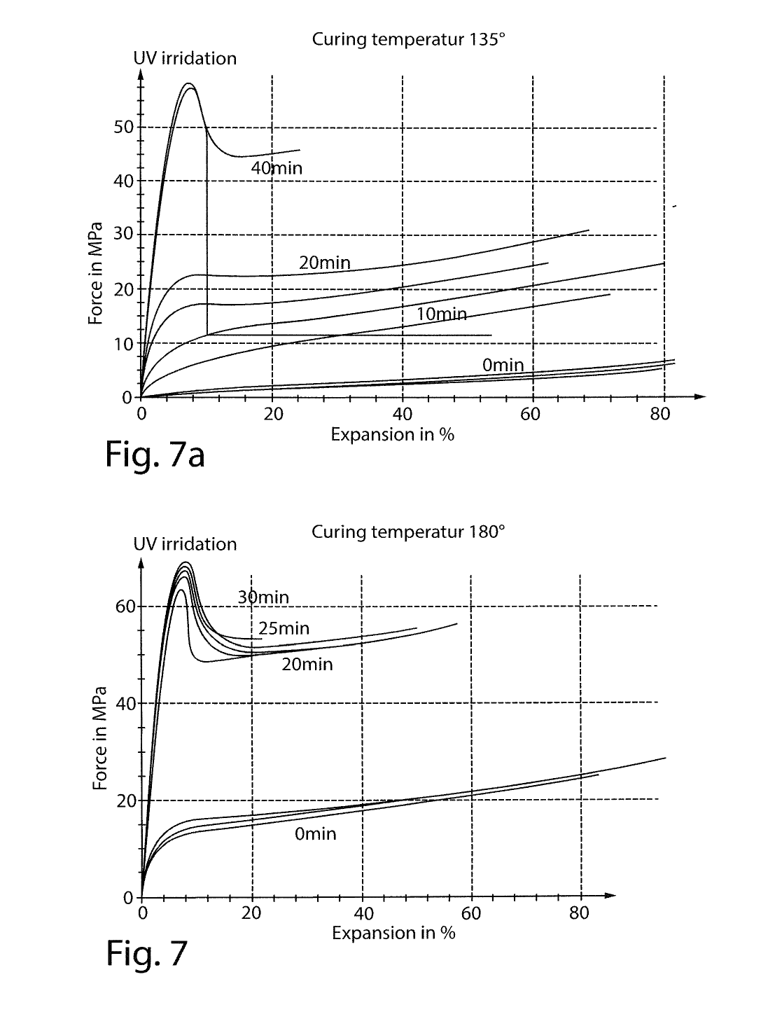

The hardness increasing effect of UV irradiation can be controlled by the irradiation time. The latter is especially significant at lower curing temperatures, for example of 135° C. As irradiation time rises, the modulus of elasticity and ultimate tensile stress increase, and elongation at break decreases noticeably. There are clearly discernible differences between 0, 10, 20 and 40 minutes of irradiation time, as illustrated by FIGS. 7a and 7b. These two figures show the results obtained from tensile tests at two different curing temperatures of 135° C. (FIG. 7a) and 180° C. (FIG. 7b) for the varying irradiation times. At higher curing temperatures, for example at 180° C., the irradiation time can be sharply decreased. Starting at an irradiation time of 20 minutes, no further increase can be discerned in the modulus of elasticity and ultimate tensile stress.

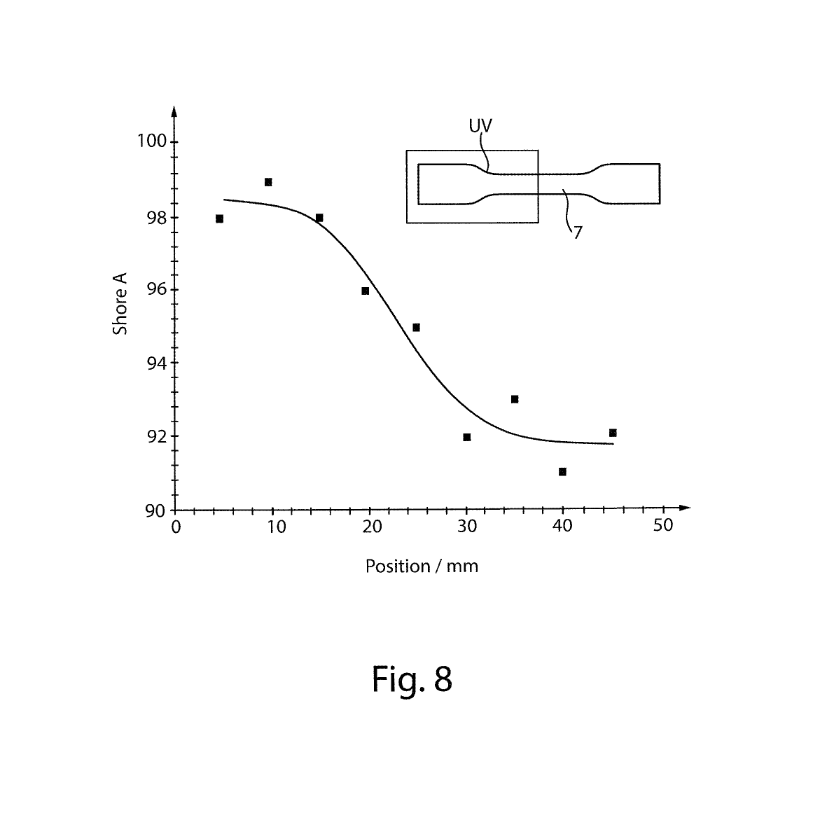

An examination was also performed to determine whether the hardness increasing effect of UV irradiation actually remains limited to the irradiated area, or extends into the non-irradiated area during the thermal curing reaction. As documented by the result shown on FIG. 8, the effect of UV irradiation on mechanical behavior in fact remains local. The test rod 7 fabricated for the tensile test was here only exposed to UV radiation on the left side, as denoted in the upper right-hand part of the figure. A lightproof cover was placed over the right side of the test rod during irradiation. FIG. 8 shows how the Shore A indentation hardness changes over the length of such a test rod. It is significantly elevated on the irradiated side.

Studies conducted on formulations and fully cured samples via differential calorimetry (DCS) provided insight into the causes for the mechanically highly variable behavior. These studies confirm that UV irradiation actually triggers another cross-linking reaction, which increases the hardness of the samples in addition to curing with the anhydride. Furthermore, this also made it possible to verify that the cationic polymerization of epoxy groups also contributes to the reaction of the anhydride with OH and epoxy groups for cross linking purposes in the irradiated sample. Cationic polymerization here sets in earlier than anhydride curing. For this reason, the curing reaction in the irradiated formulation already begins at about 70° C., reaches a maximum speed at about 130° C., and, just as with the reaction in the non-irradiated sample, had concluded at about 180° C.

In specific methods, for example when using the formulations according to the invention in adhesives that are processed as adhesive films, it may be necessary to utilize high-molecular epoxy resins that are solid at room temperature. For this reason, it was verified that the formulation according to the invention can be carried over to higher-molecular BPA resins. However, solid formulations could not be mixed and processed into specimens. This is why a solution of the examined Epikote 1004 solid resin had to be used. The solution was advantageously manufactured in the already successfully used glycidyl ether GE100. As a comparison, a test was also performed on a mixture of the glycidyl ether GE100 with the OH-poor, low-molecular liquid resin Epilox A 19-03 not encompassed by the invention. IR spectra can be used to demonstrate that the BPA-based liquid resin Epilox A 19-03 is poor in OH groups. By contrast, the also BPA-based, but high-molecular resin Epikote 1004 exhibits a content of OH-groups that even exceeds that of the successfully tested liquid resin glycidyl ether GE100.

For example, a high-viscosity formulation according to the invention can be manufactured with Epikote 1004 and glycidyl ether GE100 as follows:

40 g of glycidyl ether GE100 from Raschig are placed in a sealable container with a mechanical agitator. 10 g of Epikote 1004 from Momentive are then added while stirring. The solid resin is slowly solubilized while being stirred, and the viscosity of the solution distinctly increases. In order to solubilize remaining solid particles even after prolonged stirring, the solution is heated to 135° C. and stirred while warm. This yields a clear, slightly yellowish, viscous resin solution.

2 g of glycidyl ether GE100, Raschig, are placed in a PP disposable cup, and 9 g of the Epikote 1004 solution are added. 4.2 g of hexahydrophthalic acid anhydride are then fused via heating in the drying closet at 50-60° C., whereupon 0.8 g of a solution of anhydrous zinc chloride in acetylacetone hot saturated at 80° C. and 0.3 g of Irgacure 250, BASF SE, are added. Each addition is followed by thorough manual mixing with a spatula. For example, air bubbles are removed from the mixture in a vacuum, and test rods are cast into silicone molds. In the formulation, the mass ratio m(Epikote 1004):m(glycidyl ether GE100)=16:84, and the stoichiometric ratio n(epoxy):n(anhydride)=1:0.38.

A formulation not encompassed by the invention with Epilox A 19-03 and glycidyl ether GE100 is manufactured as follows:

5 g of glycidyl ether GE100, Raschig, are placed in a PP disposable cup, and 5 g of Epilox A 19-03, Leuna Harze, are added. 4.2 g of hexahydrophthalic acid anhydride are then fused via heating in the drying closet at 50-60° C., whereupon 0.8 g of a solution of anhydrous zinc chloride in acetylacetone hot saturated at 80° C. and 0.3 g of Irgacure 250, BASF SE, are added. Each addition is followed by thorough manual mixing with a spatula. Air bubbles are removed from the mixture in a vacuum, and test rods are cast into silicone molds. In the formulation, the mass ratio m(Epilox A 19-03):m(glycidyl ether GE100)=1:1, and the stoichiometric ratio n(epoxy) n(anhydride)=1:0.45.

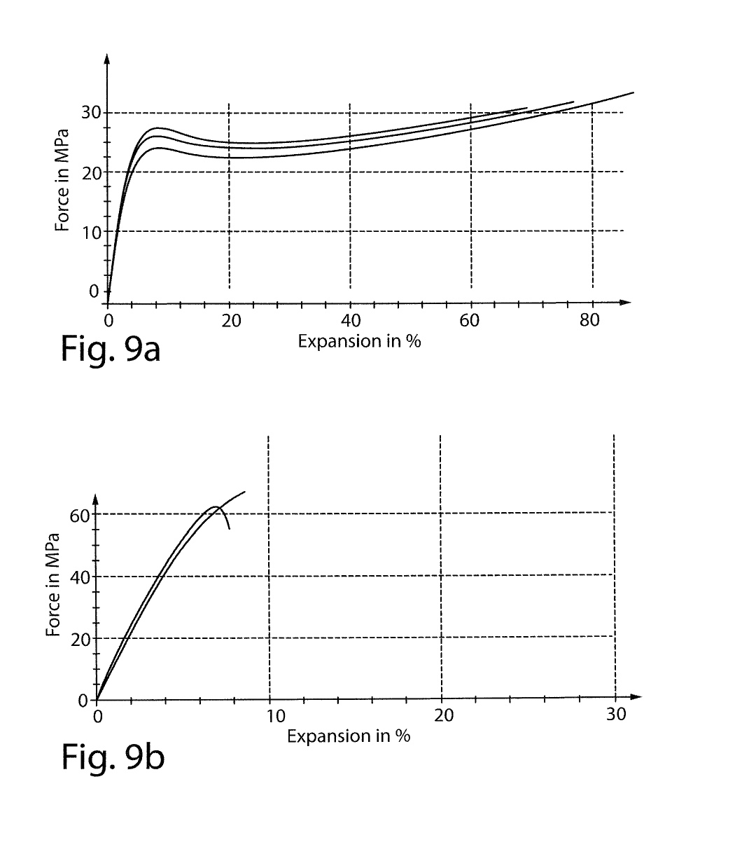

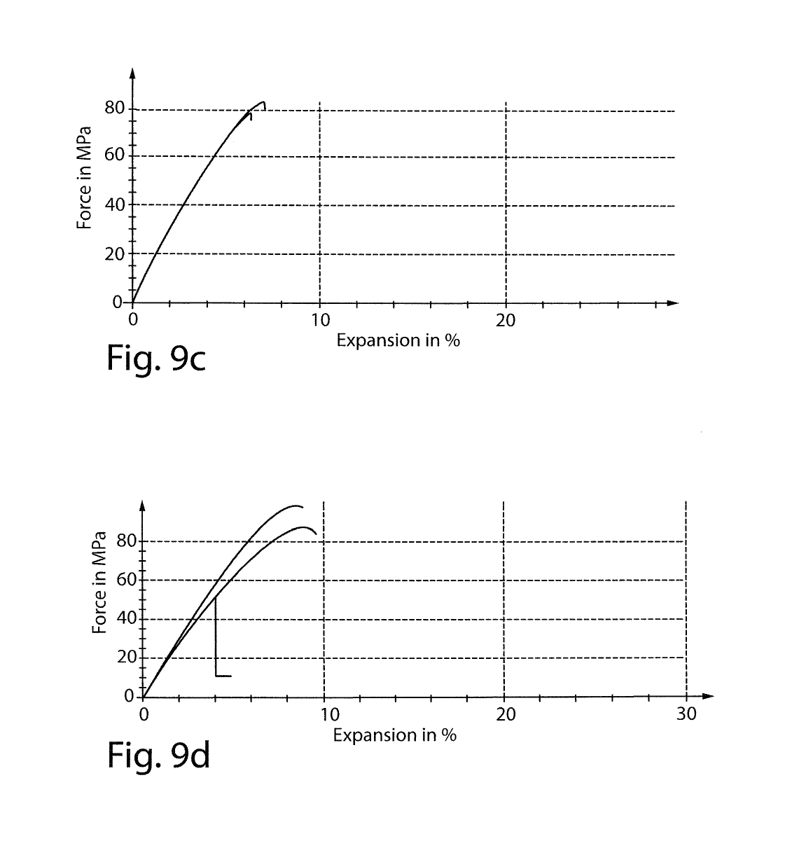

The results of the tensile elongation tests depicted on FIG. 9a-9d document that the desired variations in mechanical properties can be realized through UV irradiation only with the OH-rich formulation according to the invention. When exposed to UV irradiation, the formulation with Epikote 1004 and glycidyl ether GE100 exhibits a distinct rise in the modulus of elasticity by about 25% and a rise in the ultimate tensile stress by about 50%, which is associated with a very distinct drop in the elongation at break. The formulation with Epilox A 19-03 and glycidyl ether GE100 reveals hardly any change in the mechanical properties induced by UV irradiation.

No alkaline components are used in the epoxy resin system according to the invention described above, since they prevent cationic UV curing. This limits the possibility of this system being adjusted to process- or application-related requirements by admixing fillers or additives.

Since anhydrides accelerated with Zn salt proved especially well suited for the second reaction of the dual-cure system, curing must also always take place at high temperatures T>120° C. Sensitivity to alkaline additives is intrinsic to cationic UV curing. Therefore, it is obvious to instead use radical UV curing as the local mechanism, which is also common to the industry, and only disrupted by a few chemical functions (for example, atmospheric oxygen). As opposed to cationic UV curing, radical UV curing can so far only be used for adhesives if at least one adherend is translucent. A pre-activation prior to joining is not possible in radical UV curing, because the reaction starts immediately, and after irradiation comes to a complete stop quickly. While dual-cure systems that combine radical UV curing with a second curing process are already commercially available for lacquers and adhesives, the aim for these products is different: Radical UV curing usually takes place only during irradiation, and thus is extremely dependent on the irradiation intensity. In objects with a complex geometry or even shaded areas, it is therefore difficult to ensure that curing is universally adequate. For this reason, an attempt is made in these systems to ensure an at least sufficient curing everywhere through a combination with a second curing method. The objective had previously always been to generate a material that was as mechanically uniform as possible.

However, the expert in the field of adhesive formulation can use the information from the present patent application to strengthen precisely the previously undesired mechanical differences by adjusting the already known systems, and thereby arrive at adhesives suitable for stress peak-reduced adhesive, bonding or fabricating composites or composite layers with locally varying stiffness.

In a comparison to the especially preferred epoxy system according to the invention, the following table exemplarily cites components of already known dual-cure systems, based upon which suitable adhesive or matrix materials can also be obtained following adjustment.

| | Chemical | Chemical | Chemical | | |
|---|---|---|---|---|---|
| | functionality | functionality | functionality | Local curing | Overall curing |
| | 1 | 1 | 1 | 1 | 2 |
| Formulation | Epoxy | OH | Anhydride | Cationic UV | Thermal ≧120° C. |
| according | | | | pre- | anhydride-OH |
| to the | | | | activated | anhydride-epoxy |
| invention | | | | | |
| HENKEL | Acrylate | Epoxy | Amine | Radical UV | Thermal ≧120° C. |
| Loctite | (+acrylated | | | irradiation | Acrylate-amine |
| 3336 | epoxy resin) | | | | Epoxy-amine |
| DELO | Acrylate | NCO | H₂O | Radical | Moisture curing |
| Dualbond | (Urethane | (Urethane | (Atm. moisture | UV curing | NCO-amine |
| AD4950 | acrylate) | acrylate) | releases amine | | Acrylate-amine |
| | | | from NCO | | |

The present patent application described a dual-cure method and epoxy resin formulation suitable for the latter, with which a mechanical gradient can be generated in the adhesive layer of an adhesive bond or in the matrix material of a composite or composite layer. The scope of the difference between the mechanical properties, which is preferably generated on a locally limited basis via pre-activating UV irradiation, can be controlled by the chemical composition of the adhesive or matrix material, the irradiation time and intensity, and the temperature of the subsequent thermal curing process. The method and the formulations according to the invention achieve the technical object of generating a mechanical gradient from a single adhesive or matrix material. For example, the mechanical gradient is required to generate stress peak-reduced and hence especially strong adhesive bonds.

### Additional Exemplary Embodiment

In order to circumvent the limitations associated with the cationic UV curing of epoxy resins, systems according to the invention were also examined with a radical cross-linking mechanism as the second, locally active curing step, which is initiated through UV irradiation. An example for manufacturing a suitable adhesive formulation will first be presented below.

The proposed formulation consists of the epoxy acrylate Sartomer CN104 from Sartomer, glycidyl methacrylate, a low-molecular liquid resin Baxxores ER2200, isophorone diamine Baxxodur EC201, as well as a polyamide resin Versamid 140. Irgacure 819 served as the photoinitiator.

A formulation according to the invention was here manufactured as follows:

10 g of liquid resin Baxxores ER2200 and 7 g of Sartomer CN104 were placed in a disposable cup made of PP and heated to 60° C. in a drying closet. Both components were then mixed in a Speedmixer from Hauschild & Co KG at 2500 RPM under a vacuum for 2.5 min. Mixing was followed by the addition of 2 g of glycidyl methacrylate, 0.02 g of Irgacure 819, 1.5 g of Baxxodur and 3.4 g of Versamid 140. In a last step, the mixture was mixed for 4 min under a vacuum in the Speedmixer at 2500 RPM.

In order to manufacture specimens for tensile tests, the viscous formulation was filled into silicone molds for miniature test rods made specifically for that purpose with a disposable dropper. Irradiation was performed in a UV cube made by Hoenle, with a mercury high-pressure lamp in a cold-mirror configuration, arc length 10 cm, power 100 W/cm. The irradiation time measured 0.5 min, 1 min, 2 min and 5 min, and one sample series was not irradiated. After irradiation, the samples were transferred into the oven preheated to 80° C. The temperature was increased to 135° after 30 minutes. The oven was heated to 180° C. after another 60 minutes. The silicone molds with the specimens were removed after 60 minutes at 180° C. After cooling, the specimens could be removed from the molds. The tensile test was performed at a testing speed of 2.5 mm/min to the breaking point. In order to be able to perform hardness measurements, Teflon molds for larger test rods specially made for this purpose were filled with the formulation. They were then covered on one side with a metal plate, and irradiated in the UV cube for 5 minutes. Curing took place according to the procedure described above. The specimens removed after cooling the mold were then examined with a Shore hardness tester made by Zwick.

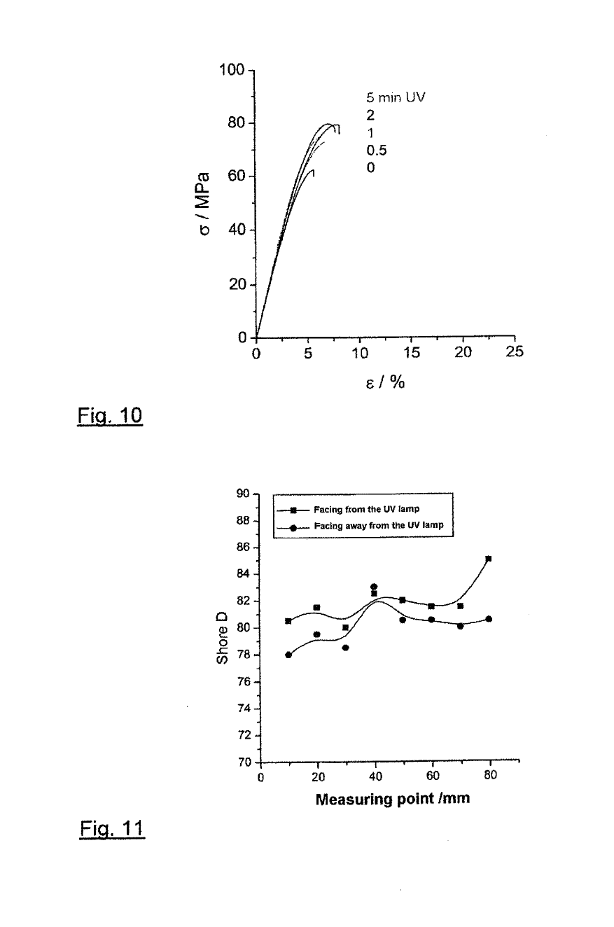

FIG. 10 presents the results obtained from the tensile tests performed on the formulation illustrated above. Along with the curve for the non-irradiated adhesive, this depiction also shows the curves for the samples exposed for varying durations. As evident from the results, a hardness-increasing effect can already be induced at an irradiation time of only 0.5 minutes. However, the latter is very small, and measures clearly below 30%. By contrast, longer irradiation times do not appear to have any further influence on the material hardness. FIG. 11 presents the progression of the surface hardness for a test rod exposed on only one side. In order to demonstrate that the curing reaction proceeds homogeneously over the entire layer thickness, the surface hardness was determined both on the side facing the UV lamp (black), as well as on the side facing away (red). A tendency toward higher values through irradiation can only be conjectured based on the curve progression. As also evident, however, the hardness of the front and rear sides is nearly identical, so that the UV curing reaction took place uniformly over the entire thickness of the sample.

In formulations according to the invention, the hardness increasing effect of such a simple dual-cure formulation comprised of an epoxy-amine system and an acrylate component is apparently insufficient. This is why the extent to which the hardness increasing effect can be enhanced by having the system incorporate a third cross-linking mechanism also triggered through UV irradiation was verified. In this case, UV irradiation as the second curing mechanism would thus trigger two different cross-linking mechanisms at the same time: In addition to the radical polymerization of the acrylate, the hardness increase was to be specifically enhanced with a thiol-ene reaction. Used for this purpose instead of the epoxy acrylate was an unsaturated, acrylated polyester resin, Desmolux XP 2764 from Bayer. Apart from the acrylate groups, which can be radically polymerized in a known manner, this resin has double bonds that can be used for further cross-linking. However, the latter are not accessible through the usual free radical polymerization process. But they can be linked together in a thiol-ene reaction with thiols and the same photoinitiator also employed for the radial polymerization of the acrylate groups, and thereby markedly increase the cross-linking density in the irradiated area.

Such a formulation according to the invention was manufactured as follows:

10 g of liquid resin Baxxores ER2200, 7 g of Desmolux XP 2764, 2 g of glycidyl methacrylate, 1.5 g of Baxxodur and 3.4 g of Versamid 140 were placed in a disposable cup made of PP. The components were mixed in a Speedmixer from Hauschild & Co KG at 2500 RPM under a vacuum. Mixing was followed by the addition of 0.02 g of Irgacure 819 and 2 g of Thiocure PETMP from Bruno Bock. In a last step, the mixture was mixed for 2.5 min in the Speedmixer at 2500 RPM under a vacuum and further processed as quickly as possible.

In order to manufacture specimens for tensile tests, the viscous formulation was filled into silicone molds for miniature test rods made specifically for that purpose with a disposable dropper. Irradiation was performed in a UV cube made by Hoenle, with a mercury high-pressure lamp in a cold-mirror configuration, arc length 10 cm, power 100 W/cm. The irradiation time measured 0.5 min, 1 min, 2 min and 5 min, and one sample series was not irradiated. After irradiation, the samples were transferred into the oven preheated to 80° C. The temperature was increased to 135° after 30 minutes. The oven was heated to 180° C. after another 60 minutes. The silicone molds with the specimens were removed after 60 minutes at 180° C. After cooling, the specimens could be removed from the molds. The tensile test was performed at a testing speed of 2.5 mm/min to the breaking point. In order to be able to perform hardness measurements, Teflon molds for larger test rods specially made for this purpose were filled with the formulation. They were then covered on one side with a metal plate, and irradiated in the UV cube for 5 minutes. UV irradiation as the second curing mechanism of the formulation described herein triggers two different cross-linking reactions at the same time, specifically a radical polymerization of the acrylate groups, as well as a thiol-ene reaction between the thiols and the double bonds of the unsaturated polyester resins. Thermal curing took place in the oven according to the manufacture of specimens for tensile tests described above. The specimens removed after cooling the mold were then examined with a Shore hardness tester made by Zwick.

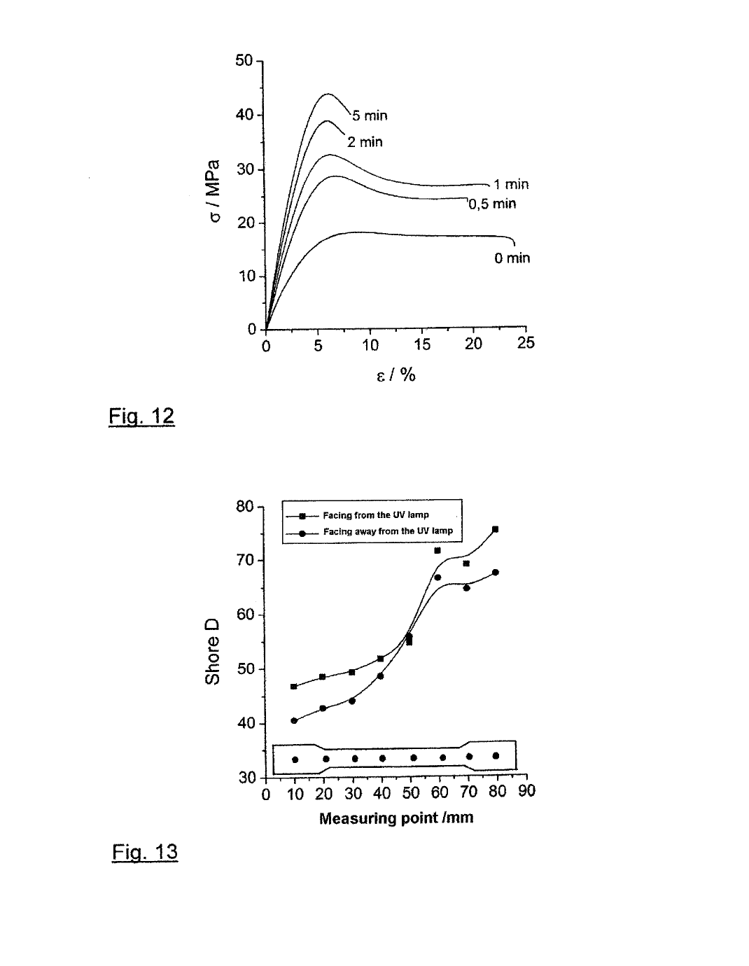

The formulation could be thermally cured both with and without irradiation. FIG. 12 presents the results of the tensile tests. The curves effectively show how the hardness and ductility of the formulation can be varied over a very wide range by means of the irradiation time. Already an irradiation lasting only 0.5 s leads to a significant increase in material hardness. By contrast, irradiation times exceeding 5 min did not bring about any further increase in hardness. A hardness increase is accompanied by a slight embrittlement of the material. Since both radical polymerization and the thiol-ene reaction do not serve to pre-activate, but rather only take place during exposure, the formulation cannot have already been cured to such an extent after irradiation as to make subsequent joining impossible. Surprisingly, the formulation remains tacky even after exposure, only becoming clearly more viscous. As a result, joining with such a formulation should be impossible. FIG. 13 shows the progression of surface hardness for a specimen, half of which was exposed. The gradual progression of Shore D hardness is very clearly discernible, wherein a large range of 40 Shore D to 70 Shore D can be covered. The values for the front and rear sides of the test rod also readily coincide, so that the curing reaction may be assumed to be homogeneous over the entire cross section of the specimen.

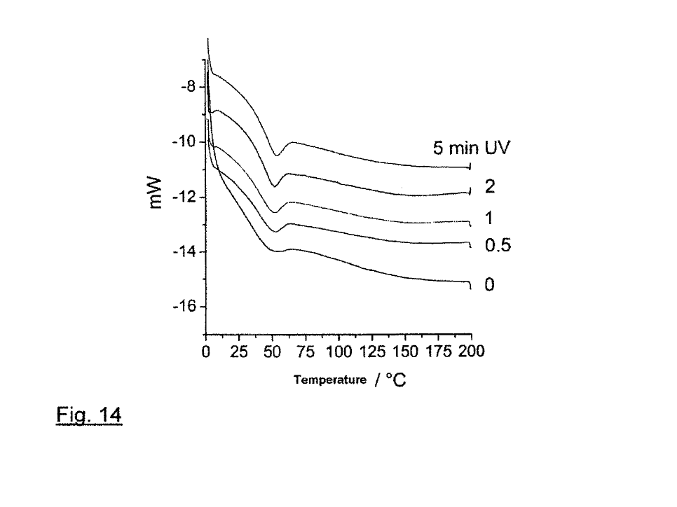

FIG. 14 presents the thermal properties of the samples exposed for varying durations. DSC measurements show that the glass transition temperature could also be slightly raised with increasing irradiation time. This also proves that irradiation is accompanied by an increase in cross-linking density. Infrared spectroscopic examinations revealed no reactive groups like epoxides, amines or thiols in significant quantities in either the exposed or unexposed cured samples. Since thiols can react very rapidly with epoxides especially when exposed to heat, it must be assumed that excess thiol will completely react in this way in the non-irradiated samples. The resultant excess amino groups can in turn be thermally completely reacted via a Michael addition with the acrylate functions. Special focus could not be placed on the latter due to overlapping. This satisfies the requirement that reactive groups must have completely reacted after curing for there to be stable product.

The stable end state is here achieved both with and without irradiation, wherein the reactive groups have completely reacted, i.e., no reactive groups are to be detectable in the finished product, which could also be verified via IR spectroscopy. Important for this purpose is that the reactive groups also be able to completely react thermally in the non-irradiated area.

In summary, let it be emphasized that the reactions encountered during thermal curing differ from those that take place during UV irradiation, as described above. The functions provided for the second curing mechanism can also completely react thermally: Thiols here react with epoxides, which allows excess amine to react with acrylates through Michael addition, leaving behind the fewest possible reactive groups, or none at all, even in the non-irradiated areas. The radical polymerization of acrylate functions or the thiol-ene reaction triggered through irradiation with UV light do not take place during the purely thermal curing of the formulation.

The information in this patent application enables the expert in the field of adhesive formulation to easily tailor dual-cure systems that are already known, but chemically different from the especially preferred embodiment so as to specifically strengthen the previously undesired inhomogeneities in the mechanical properties, thereby yielding adhesives for the stress peak-reduced adhesive bonding or corresponding matrix materials for composites.

### REFERENCE LIST

1 Adherend
2 Adhesive layer
3 UV light source
4 Additional adherend
5 Oven
6 Joined adherends
7 Test rod

1. A method for manufacturing an adhesive bond between two components, in which
an adhesive is used that can be cured with at least two different curing mechanisms, of which a first curing mechanism generates less stiffness in the adhesive than at least one second curing mechanism, and
a layer of the adhesive applied to join the components is cured with the first curing mechanism in the region between the components over the entire layer and with the at least second curing mechanism only locally, so that the stiffness of the adhesive layer varies in the region between the components.

2. A method for manufacturing a composite or composite layer composed of fibers and/or particles of a first material, which are embedded into a matrix material, in which
use is made of a matrix material that can be cured with at least two different curing mechanisms, of which a first curing mechanism generates less stiffness in the matrix material than at least one second curing mechanism, and,
after mixed with the fibers and/or particles, the matrix material is cured with the first curing mechanism over the entire composite or entire composite layer, and with the at least second curing mechanism only locally, so that the stiffness of the matrix material varies over the composite or composite layer.

3. The method according to claim 2,
characterized in that
the matrix material is cured with the first curing mechanism only on one side of the composite or composite layer, so that the stiffness of the matrix material is greater on one side of the material or layer than on the opposite side.

4. The method according to claim 1,
characterized in that
the layer of adhesive is locally cured with the at least second curing mechanism given an overlapping adhesive bond in such a way that the stiffness of the adhesive layer in the overlapping region decreases from the middle of the overlap toward the edges.

5. The method according to claim 1,
characterized in that
the adhesive is locally cured with the at least second curing mechanism in such a way as to obtain a continuous progression for the stiffness over the layer.

6. The method according to claim 1,
characterized in that
the adhesive is selected and cured in such a way that the stiffness of the adhesive varies by at least 30% over the layer.

7. The method according to claim 1,
characterized in that
thermal curing is used as the first curing mechanism.

8. The method according to claim 1,
characterized in that
UV curing is used as the at least second curing mechanism.

9. The method according to claim 8,
characterized in that
the stiffness achieved with the at least second curing mechanism is varied by means of the UV intensity and/or irradiation time.

10. The method according to claim 8,
characterized in that
the adhesive is selected in such a way that the at least second curing mechanism initially only modifies the adhesive in a first stage through exposure to UV radiation, and final curing by the at least second curing mechanism only takes place in a second stage through thermal exposure.

11. The method according to claim 10,
characterized in that
the layer of adhesive is first applied to one of the components and locally irradiated with UV radiation, after which the two components are joined together, whereupon the first curing mechanism is initiated, and curing with the at least second curing mechanism through thermal exposure is concluded.

12. The method according to claim 1,
characterized in that
use is made of an adhesive which
exhibits at least one first type of chemical functions, which are reactive in both the first and at least in the second curing mechanism,
exhibits at least one second type of chemical functions, which are reactive in the first curing mechanism, and
exhibits at least one third type of chemical functions, which as cross linking agents can react with both the first and second type of chemical functions, and that both the first curing mechanism and second curing mechanism yield a stable end state in which the reactive groups have completely reacted.

13. The method according to claim 12,
characterized in that
use is made of an adhesive in which the first and second chemical functions are present together on molecules of the adhesive.

14. The method according to claim 12,
characterized in that
use is made of an adhesive in which the first type of chemical functions consists of epoxy groups, the second type of chemical functions consists of OH groups, and the third type of chemical functions consists of the carboxylic acid function and/or carboxylic acid anhydride function.

15. The method according to claim 14,
characterized in that
use is made of an adhesive in which the OH groups are present in a quantity sufficient for reactively binding excess anhydride or carboxylic acid formed from the latter that were not made to react by the epoxy groups in the curing process.

16. The method according to claim 12,
characterized in that
use is made of an adhesive in which a stoichiometric ratio between the components carrying the first type of chemical functions and the components carrying the third type of chemical functions is greater than 1:0.7.

17. The method according to claim 1,
characterized in that
thermal curing is used as the first curing mechanism, and UV curing is used as the at least second curing mechanism,
and that UV curing takes place with at least two different UV-initiated cross-linking mechanisms.

18. The method according to claim 17,
characterized in that
radical polymerization takes place as the first cross-linking mechanism, and that
double bonds in one component of the adhesive react with thiols, and cross-linking takes place by way of a thiol-ene reaction as the second cross-linking mechanism.

19. The method according to claim 17,
characterized in that
use is made of an adhesive that
exhibits at least one first type of chemical functions, which are reactive in the first curing mechanism,
exhibits at least one second type of chemical functions, which are reactive both in the first and at least in the second curing mechanism,
exhibits at least one third type of chemical functions, which as cross-linking agents can react both with the first and second type of chemical functions,
exhibits at least one fourth type of chemical functions, which are reactive both in the first and at least in the second curing mechanism, and
both the first curing mechanism and the at least second curing mechanism yield a stable end state in which reactive groups have reacted completely.

20. The method according to claim 19,
characterized in that
use is made of an adhesive in which the first type of chemical functions consists of epoxy groups, the second type of chemical functions consists of acrylate groups, the third type of chemical functions consists of amine groups, and the fourth type of chemical functions consists of thiol groups.

21. An adhesive, in particular for manufacturing an adhesive bond according to claim 1,
which can be cured with at least two different curing mechanisms, of which a first curing mechanism generates less stiffness in the adhesive than at least one second curing mechanism,
and which
exhibits at least one first type of chemical functions, which are reactive both in the first and at least in the second curing mechanism,
exhibits at least one second type of chemical functions, which are reactive at least in the second curing mechanism, and
exhibits at least one third type of chemical functions, which as cross-linking agents can react both with the first and second type of chemical functions,
wherein the first type of chemical functions consists of epoxy groups, the second type of chemical functions consists of OH groups, and the third type of chemical functions consists of the carboxylic acid function and/or carboxylic acid anhydride function.

22. The adhesive according to claim 21,
characterized in that
the first and second chemical functions are present together on molecules of the adhesive.

23. The adhesive according to claim 21,
characterized in that
the OH groups are present in a quantity sufficient for reactively binding excess anhydride or carboxylic acid formed from the latter that were not made to react by the epoxy groups in the curing process.

24. The adhesive according to claim 21,
characterized in that
a stoichiometric ratio between the components carrying the first type of chemical functions and the components carrying the third type of chemical functions is greater than 1:0.7.

25. An adhesive, in particular for manufacturing an adhesive bond according to claim 17,
which can be cured with at least two different curing mechanisms, of which a first curing mechanism generates less stiffness in the adhesive than at least one second curing mechanism,
and which
exhibits at least one first type of chemical functions, which are reactive in the first curing mechanism,
exhibits at least one second type of chemical functions, which are reactive both in the first and at least in the second curing mechanism,
exhibits at least one third type of chemical functions, which as cross-linking agents can react both with the first and second type of chemical functions, and
exhibits at least one fourth type of chemical functions, which are reactive both in the first and at least in the second curing mechanism.

26. The adhesive according to claim 25, characterized in that the first type of chemical functions consists of epoxy groups, the second type of chemical functions consists of acrylate groups, the third type of chemical functions consists of amine groups, and the fourth type of chemical functions consists of thiol groups.

27. The method according to claim 2,
characterized in that
the matrix material is locally cured with the at least second curing mechanism in such a way as to obtain a continuous progression for the stiffness over the layer or material.

28. The method according to claim 2,
characterized in that
the matrix material is selected and cured in such a way that the stiffness of the matrix material varies by at least 30% over the material.

29. The method according to claim 2,
characterized in that
thermal curing is used as the first curing mechanism.

30. The method according to claim 2,
characterized in that
UV curing is used as the at least second curing mechanism.

31. The method according to claim 30,
characterized in that
the stiffness achieved with the at least second curing mechanism is varied by means of the UV intensity and/or irradiation time.

32. The method according to claim 2,
characterized in that
use is made of a matrix material which
exhibits at least one first type of chemical functions, which are reactive in both the first and at least in the second curing mechanism,
exhibits at least one second type of chemical functions, which are reactive in the first curing mechanism, and
exhibits at least one third type of chemical functions, which as cross linking agents can react with both the first and second type of chemical functions, and that both the first curing mechanism and second curing mechanism yield a stable end state in which the reactive groups have completely reacted.

33. The method according to claim 32,
characterized in that
use is made of a matrix material in which the first and second chemical functions are present together on molecules of the matrix material.

34. The method according to claim 32,
characterized in that
use is made of a matrix material in which the first type of chemical functions consists of epoxy groups, the second type of chemical functions consists of OH groups, and the third type of chemical functions consists of the carboxylic acid function and/or carboxylic acid anhydride function.

35. The method according to claim 34,
characterized in that
use is made of a matrix material in which the OH groups are present in a quantity sufficient for reactively binding excess anhydride or carboxylic acid formed from the latter that were not made to react by the epoxy groups in the curing process.

36. The method according to claim 32,
characterized in that
use is made of a matrix material in which a stoichiometric ratio between the components carrying the first type of chemical functions and the components carrying the third type of chemical functions is greater than 1:0.7.

37. The method according to claim 2,
characterized in that
thermal curing is used as the first curing mechanism, and UV curing is used as the at least second curing mechanism,
and that UV curing takes place with at least two different UV-initiated cross-linking mechanisms.

38. The method according to claim 37,
characterized in that
radical polymerization takes place as the first cross-linking mechanism, and that double bonds in one component of the matrix material react with thiols, and cross-linking takes place by way of a thiol-ene reaction as the second cross-linking mechanism.

39. The method according to claim 37,
characterized in that
use is made of a matrix material that
exhibits at least one first type of chemical functions, which are reactive in the first curing mechanism,
exhibits at least one second type of chemical functions, which are reactive both in the first and at least in the second curing mechanism,
exhibits at least one third type of chemical functions, which as cross-linking agents can react both with the first and second type of chemical functions,
exhibits at least one fourth type of chemical functions, which are reactive both in the first and at least in the second curing mechanism, and
both the first curing mechanism and the at least second curing mechanism yield a stable end state in which reactive groups have reacted completely.

40. The method according to claim 39,
characterized in that
use is made of a matrix material in which the first type of chemical functions consists of epoxy groups, the second type of chemical functions consists of acrylate groups, the third type of chemical functions consists of amine groups, and the fourth type of chemical functions consists of thiol groups.

41. A matrix material, in particular for manufacturing a composite layer according claim 2,
which can be cured with at least two different curing mechanisms, of which a first curing mechanism generates less stiffness in the matrix material than at least one second curing mechanism,
and which
exhibits at least one first type of chemical functions, which are reactive both in the first and at least in the second curing mechanism,
exhibits at least one second type of chemical functions, which are reactive at least in the second curing mechanism, and
exhibits at least one third type of chemical functions, which as cross-linking agents can react both with the first and second type of chemical functions,
wherein the first type of chemical functions consists of epoxy groups, the second type of chemical functions consists of OH groups, and the third type of chemical functions consists of the carboxylic acid function and/or carboxylic acid anhydride function.

42. The matrix material according to claim 41,
characterized in that
the first and second chemical functions are present together on molecules of the matrix material.

43. The matrix material according to claim 41,
characterized in that
the OH groups are present in a quantity sufficient for reactively binding excess anhydride or carboxylic acid formed from the latter that were not made to react by the epoxy groups in the curing process.

44. The matrix material according to claim 41,
characterized in that
a stoichiometric ratio between the components carrying the first type of chemical functions and the components carrying the third type of chemical functions is greater than 1:0.7.

45. A matrix material, in particular for manufacturing a composite layer according to claim 37,
which can be cured with at least two different curing mechanisms, of which a first curing mechanism generates less stiffness in the matrix material than at least one second curing mechanism,
and which
exhibits at least one first type of chemical functions, which are reactive in the first curing mechanism,
exhibits at least one second type of chemical functions, which are reactive both in the first and at least in the second curing mechanism,
exhibits at least one third type of chemical functions, which as cross-linking agents can react both with the first and second type of chemical functions, and
exhibits at least one fourth type of chemical functions, which are reactive both in the first and at least in the second curing mechanism.

46. The matrix material according to claim 45, characterized in that the first type of chemical functions consists of epoxy groups, the second type of chemical functions consists of acrylate groups, the third type of chemical functions consists of amine groups, and the fourth type of chemical functions consists of thiol groups.
